(19) United States
(12) Patent Application Publication
(10) Pub. No.: US 2018/0131651 A1
(43) Pub. Date: May 10, 2018

(54) SYSTEM AND A METHOD FOR LIMITING THE WASTE OF TIME OF READING NON-USEFUL EMAILS

(71) Applicant: PMTP SA, Lugano (CH)

(72) Inventor: Alfredo VILLA, Lugano Pregassona (CH)

(21) Appl. No.: 15/345,974

(22) Filed: Nov. 8, 2016

(51) Int. Cl. H04L 12/58; G06Q 20/10

(52) U.S. Cl. CPC H04L 51/12; G06Q 20/10; H04L 51/04

(57) ABSTRACT

A method for managing a transmission of emails from a sender to a recipient, including the steps of: (a) providing a server system including one or more servers, the server system including a processing unit; (b) providing a recipient list to the server system, including identification of one or more recipients; (c) providing a sender list for each recipient of the recipient list to the server system, the sender list including identification of one or more authorized senders; the processing unit: (s1) receives an email sent by a sender towards a recipient of the recipient list; (s2) prevents transmission of the email from the server system to the recipient until the sender is an authorized sender; (s3) assigns a work value to the emails transmitted to the recipient; (s4) counts the total work value of the emails transmitted to the recipient.

### FIELD OF THE INVENTION

The present invention relates to a system and a method for managing transmission of emails from a sender to a recipient. In particular, the present invention relates to a system and a method for limiting the waste of time of reading non-useful emails.

### BACKGROUND OF THE INVENTION

Systems for filtering the incoming email of a user are known in the art, typically as “spam filters” or “spam blockers”. Spam filters usually blocks all the emails coming from predetermined users.

Advanced spam filters analyze the content of the email to determine if an email should be blocked or not. However, such an analysis is carried out by a machine, which is not actually capable of evaluating the importance of an email. Typically the “analysis” of the spam filters is limited to the search for “undesired” catch words (e.g. “offer”, “buy”, and “discount”), the excessive use of images, etc.

As a result, not all the undesired emails can be blocked. Furthermore, some useful emails may be blocked, too, disadvantageously for the final user, i.e. the recipient.

In addition, a professional may receive a great number of emails from his/her clients.

The professional needs to spend time in reading and answering these emails. Such a time is often not profitable, as generally it is not paid. Furthermore, it diminishes the time available to the professional for other profitable activities.

In these circumstances it is not possible to apply a spam filter to the clients because important emails may be blocked. Moreover, it is complex to evaluate the time spent for the emails, and to get paid for them.

As a result, there is the need for improved method and system for managing transmission of an email between a sender and a recipient.

### SUMMARY OF THE INVENTION

It is an object of an embodiment of the present invention to provide such improved method and system.

In particular, it is an object of an embodiment of the present invention to provide a method and a system allowing avoiding waste of time in reading non-profitable emails.

It is a further object of the present invention to provide a method and a system to filter incoming emails from a sender to a recipient.

These and other objects are achieved by a method and a system according to the independent claims.

Preferred embodiments are recited in the dependent claims.

According to an embodiment, a method for managing transmission of emails from a sender to a recipient comprises the steps of:
(a) providing a server system comprising one or more servers, the server system comprising a processing unit;
(b) providing a recipient list to the server system, comprising identification of one or more recipients;
(c) providing a sender list for each recipient of said recipient list to the server system, said sender list comprising identification of one or more authorized senders; wherein the processing unit
(s1) receives an email sent by a sender towards a recipient of said recipient list;
(s2) prevents transmission of the email from the server system to the recipient until the sender is an authorized sender;
(s3) assigns a work value to the emails transmitted to the recipient;
(s4) counts the total work value of the emails transmitted to the recipient.

It should be noted that the “list” may be of any known kind that can be read and managed by the server system (in particular by the processing unit of the server system), and it is typically a digital database.

Thanks to the present embodiment, the recipient can only receive emails from authorized senders that are chosen by the recipient himself. As better discussed later, non-authorized senders (i.e. senders that are not present in the sender list of a recipient) may become authorized sender following a pre-determined procedure. If a sender fails to become an authorized user, waste of time is prevented to the recipient.

Moreover, the recipient may become aware immediately of the work value associated to an email before reading it, so waste of time is avoided. As an example, he may reply to the sender, without reading the email, informing the latter that he may not actually read the email and answer to it before a certain date.

The work value is generally a numeric value. As an example, it may represent the number of estimated hours that the recipient should use to read and answer to the email (including the time needed to perform the operations possibly asked by the sender in the email). As a further example, it may represent an amount of money. As better discussed later, such an amount of money should be paid by the sender before sending the email. Alternatively, the amount of money should be paid by the sender after the answer of the recipient; otherwise the sender becomes a non-authorized sender, etc.

Various parameters may be used to the processing unit to evaluate the work value. They are typically chosen together with the recipient.

Preferably, at least one of said parameters is selected from: number of words of the email, kind of task(s) to be executed by the recipient, number of tasks to be executed by the recipient, name of sender, number of emails sent by the sender towards the recipient in a predetermined period.

In particular, one first parameter can be the number of words of the email. The more the email is long, the more the work value is high.

In a further embodiment, the processing unit is capable of evaluating the kind and/or the number of task(s) to be executed to answer the email. As an example, the presence of catchwords in the email may suggest that the sender is asking for a certain operation. Otherwise, the sender can be forced (e.g. through a web portal) to send an email compiling a pre-determined form. As an example, a recipient knows that his clients usually ask him to carry out tasks A, B or C. As a result, the sender may be forced to send an email compiling a form, having three sections, one for each task A, B and C. A sender willing to ask a recipient to perform a task of the kind “C”, will thus compile only the relevant section associated to task C. A certain work value is associated to each of tasks A, B and C.

A further parameter may be the name of the sender. As an example, a recipient may know that the operations needed to answer the emails of a certain sender are particularly complex and long. The work value of the emails coming from such a sender may thus be increased with respect to the others. Alternatively, e.g. when the work value is used to determine a fee to be paid by the sender, it is possible that the recipient applies a discount to certain senders (e.g. regular clients). The work value associated to the emails coming from such a sender may thus be lowered with respect to the emails of other senders.

A further parameter may be the number of emails sent by a sender to the recipient in a predetermined period. As an example, assuming that a sender sends the same emails twice in a week, the work value of the second email may be greater than the work value of the first email. This is particularly useful in case the work value is converted into a fee, to avoid spam, or unwanted and futile emails, from a certain sender.

As already mentioned, according to an aspect, the work value may be converted into a fee to be paid by the sender to the recipient.

The sender is thus discouraged in sending non-useful emails to a recipient.

Furthermore, according to an embodiment, the processing unit prevents transmission of emails from a sender to a recipient until the fee is paid.

In particular, it may be the case that the sender has to pay a fee for having its actual email transmitted to the recipient. In other words, when the recipient receives an email, he receives the payment of a fee related to such an email as well.

As a result, the recipient spends time and resources in reading and answering emails for which a fee has been paid by the sender. The fee pays this time spent by the recipient.

Preferably, part of the fee is credited to the recipient, while the other part is typically credited to the provider of the service, e.g. the owner of the server, the owner of the software implementing the above mentioned method, etc.

Furthermore, waste of time (and money) in reading (and possibly answering) undesired emails is avoided. In fact, a sender may recognize that its email is not worth the fee, i.e. it has no or little importance. Thanks to the present embodiment, the email does not reach the recipient.

It may also be the case that a sender may decide to pay the fee, even if the importance of the email is of no or little importance. Payment of the fee pays the recipient back of the time spent (i.e. “wasted” in the present case) in reading the email.

In a different embodiment, the fee is due at the response of the recipient. As an example, the sender is prevented to send further emails until the fee for the previous one is paid. This can be carried out e.g. by deleting the sender from the sender list of the recipient at the response of the recipient. Once the sender pays the relevant fee, he is added back to the sender list.

According to an embodiment, when the processing unit determines that the sender of an email is not cited in the sender list of the recipient (i.e. when the processing unit determines that the sender is not an authorized sender), the processing unit asks the recipient (e.g. via an automated email) to add the recipient to the sender list.

The recipient may thus decide to either add the sender to the sender list or not. In the first case, the email reaches the recipient, in the second case the transmission of the email is blocked. A user may decide to let every non-authorized user to become an authorized user, e.g. via payment of a fee. Furthermore, a recipient may provide the server system with a block list of blocked sender, i.e. a list of users that may never become authorized users, independently from the payment of the relevant fee.

Thanks to this, the recipient may decide that some senders should not be never able to send him any email. This further helps in avoiding waste of time for the recipient.

It should be noted that a “sender list” and a “block list” are identified. It may be the case that the sender list and the block list are part of a single list. As an example, a single database may contain the information that a first sender is authorized, and that he may send emails to the recipient, while a second sender is blocked, so that no emails of the second sender can reach the relevant recipient.

According to an embodiment, the server system comprises a memory, the recipient list and/or the sender list being stored on the memory.

This allows the processing unit to perform quickly the steps of the method mentioned above.

According to an embodiment, the server system hosts a web platform, configured to accept a number of registered users. Preferably, the recipients of the recipient list are registered users of the web platform. The operation of “registering” to a web platform is known in the field of web platforms.

Thanks to the web platform, the recipient(s) can easily interact with the server system. As a result they can e.g. provide to the server system the sender list of authorized senders, provide the information relating the parameter to evaluate the work value, etc. According to an embodiment, also senders may register themselves to the web platform, so as to e.g. memorize their data and to be easily recognized by the processing unit, memorize a payment method to speed up operation of sending emails, etc.

According to an embodiment, the processing unit, after the step (s1) of receiving an email from a sender determines that the sender is not registered to the web platform and invites the sender to register to the web platform.

As mentioned, an email from a registered sender is processed faster that an email from a non-registered sender.

Furthermore, the recipients may be informed that a new registered user has joined the web platform, asking them if they want to add the new user to their sender list, i.e. to make the new user an authorized sender.

It has to be noted that a distinction has been made between “sender” and “recipient”. This distinction is relevant for the single email, but it does not necessarily divide the users of the web platform into two distinct categories. In fact, a first registered user of the web platform may send an email to a second registered user, and subsequently receive an email from a third registered user. In the first case, the first registered user is a “sender”, while in the second case the first user is the “recipient”.

As a result, each user of the web platform can be selectively a sender or a receiver. As a result, each registered user of the web platform may be asked to provide a sender list (to allow receiving of emails, i.e. to act as a “recipient”) and e.g. to indicate a payment method (to allow payment of fee possibly related in sending an email to another user, so that he may act as a “sender”, while the other user acts as a “recipient”).

A registered user interested only in receiving emails may thus skip providing payment methods, while a registered user interested only in sending emails may skip providing a sender list.

According to an embodiment, the recipients have an email account on a server of the server system.

Thanks to this, the server system may easily manage the incoming emails of a recipient. An embodiment of the present invention further provides for a system for managing transmission of emails from a sender to a recipient, the system comprising a server system comprising one or more servers and being configured to obtain:

a recipient list comprising identification of one or more recipients;

a sender list for each recipient of said recipient list, said sender list comprising identification of one or more senders

wherein the server system is configured to run computer executable instructions to receive an email sent by a sender towards a recipient of said recipient list;

prevent transmission of the email from the server system to the recipient until the sender is an authorized sender;

assign a work value to the emails transmitted to the recipient;

count the total work value of the emails transmitted to a recipient.

### BRIEF DESCRIPTION OF THE DRAWINGS

Other feature, advantages and details appear, by way of example only, in the following detailed description of embodiments, with reference to the accompanying drawings, in which:

FIG. 1 is a schematic view of an embodiment of the present invention;

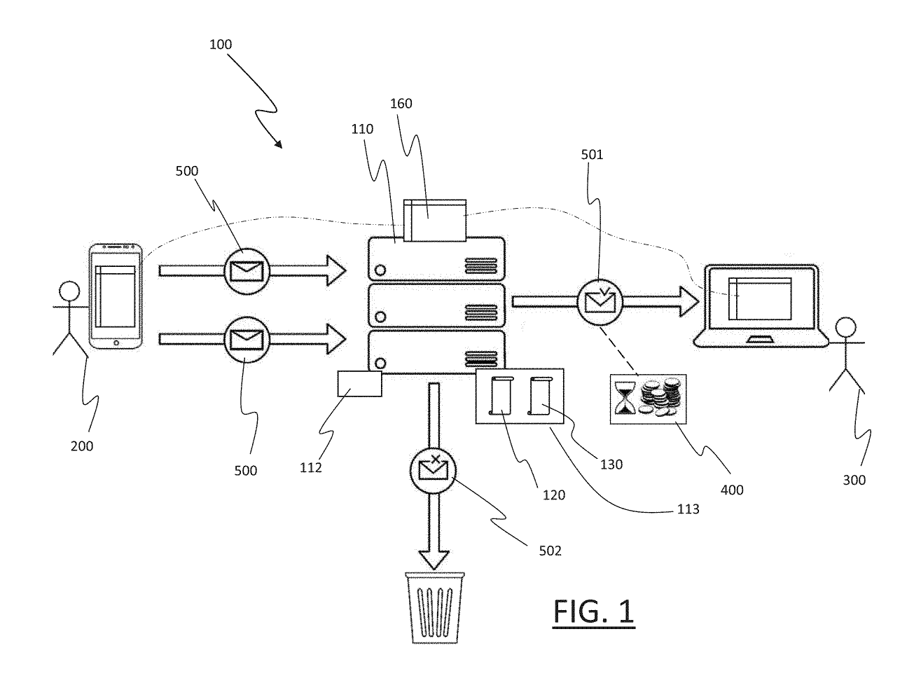

FIG. 2 is a schematic view of a recipient list of an embodiment of the present invention;

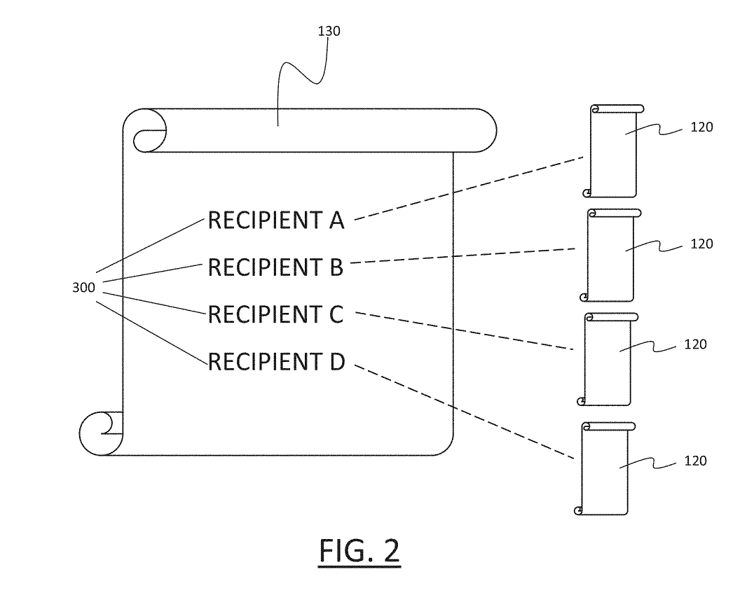

FIG. 3 is a schematic view of the content of a memory of a servers system of an embodiment of the present invention;

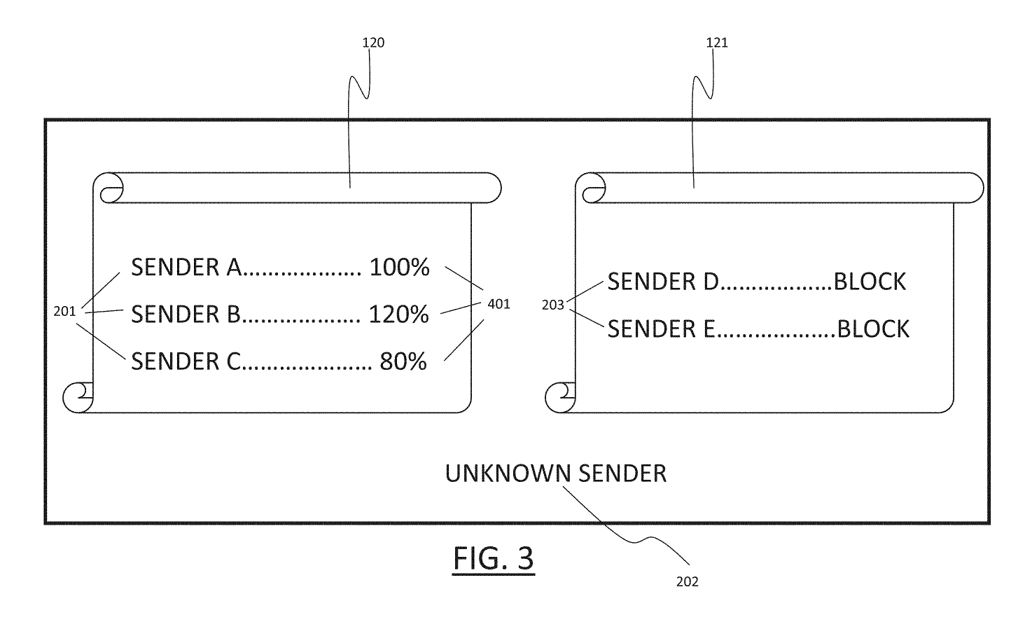

FIG. 4 is a schematic view of the content of FIG. 3, organized in a database;

FIG. 5 is a schematic view of management of the emails between registered and non-registered users of a web platform of an embodiment of the invention;

FIG. 6 is a schematic view of a web page of the web platform, used to send an email to a registered user of the web platform.

FIG. 7 is a schematic view of an exemplary evaluation of the work value of an email.

### DETAILED DESCRIPTION OF INVENTION

Exemplary embodiments will now be described with reference to the enclosed drawings without intent to limit application and uses.

According to an embodiment, a system 100 for managing transmission of emails 500, 501, 502 from a sender 200, 201, 202, 203 to a recipient 300. The system 100 comprises a server system 110 comprising one or more servers 111 and a processing unit 112.

In the figures, only one server 111 is shown. In other embodiments, a plurality of servers 111 may be connected in a known way, typically by means of a network over the Internet, to form a server system 110.

It should be also noted that numeric reference 500 is assigned to emails before reaching the server system, while numeric reference 501, 502 are assigned to emails after being processed by the server system 100 (in more detail by the processing unit 112 of the server system 100).

As better discussed later, emails transmitted form the server system 100 to the recipient are referenced as emails 501, while email not reaching the recipient 300 are hereinafter referenced as emails 502.

The server system 100 is configured to obtain a recipient list 130 comprising identification of one or more recipients 300 and a sender list 120 for each recipient 300 of said recipient list 130. The sender list 120 comprises identification of one or more authorized senders 201.

A sender that is not on the sender list 120 of a relevant recipient 300 is a non-authorized sender 202 for the recipient 300.

In an embodiment, the server system 100 is also configured to obtain a block list 121 for one or more of the recipients 300 of the recipient list 130. The block list 121 contains identification of one or more blocked senders 203 for a recipient.

It should be noted that when reference is made to a generic sender 200, he/she may be either an authorized sender 201, a non-authorized sender 202 or a blocked sender 203, or in general to a sender sending an email to a recipient 300.

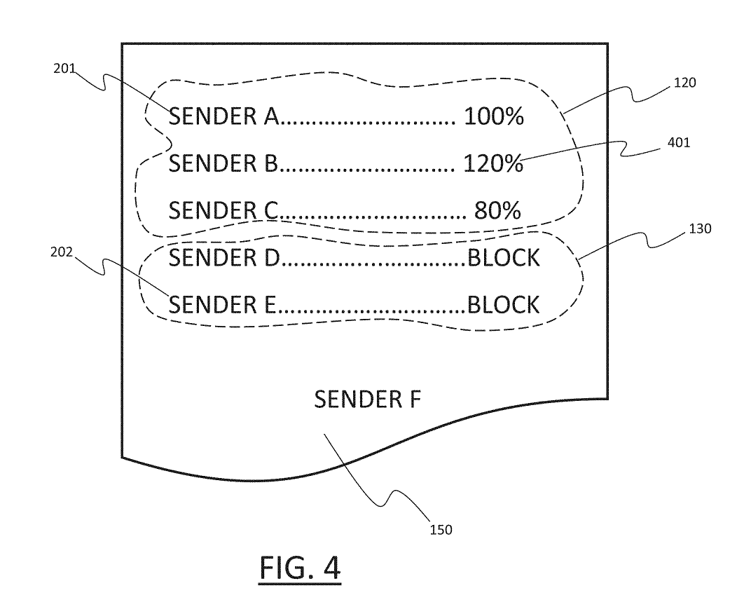

Sender list 120 block list 121, and possibly also data relating parameters 401-404 (better discussed later) to evaluate the work load 400 for an email 500 were disclosed as being separate and distinct elements. As shown in FIG. 4, they may be part of a single database 150.

According to an embodiment, the server system 100 is provided with a memory 113 to store, among others, the recipient list 130 and/or the sender list 120 and/or the block list 121.

In different embodiment, the above mentioned data may be stored remotely, i.e. not on the server system 100. In such an embodiment, the server system 100 should be able to retrieve the data when needed, e.g. by means of a proper connection (e.g. cabled or wireless) to the place wherein the data is stored.

The processing unit is programmed to assign a work value 400 for each email 501 reaching a recipient 300.

As mentioned, the work value 400 is typically assigned to the emails 501 as a function of one or more parameters 401, 402, 403, 404.

In the figures, four kinds of parameters 401, 402, 403, 404 are shown. Different parameters may be used as well in addition or replacement of one or more of the cited parameters 401-404.

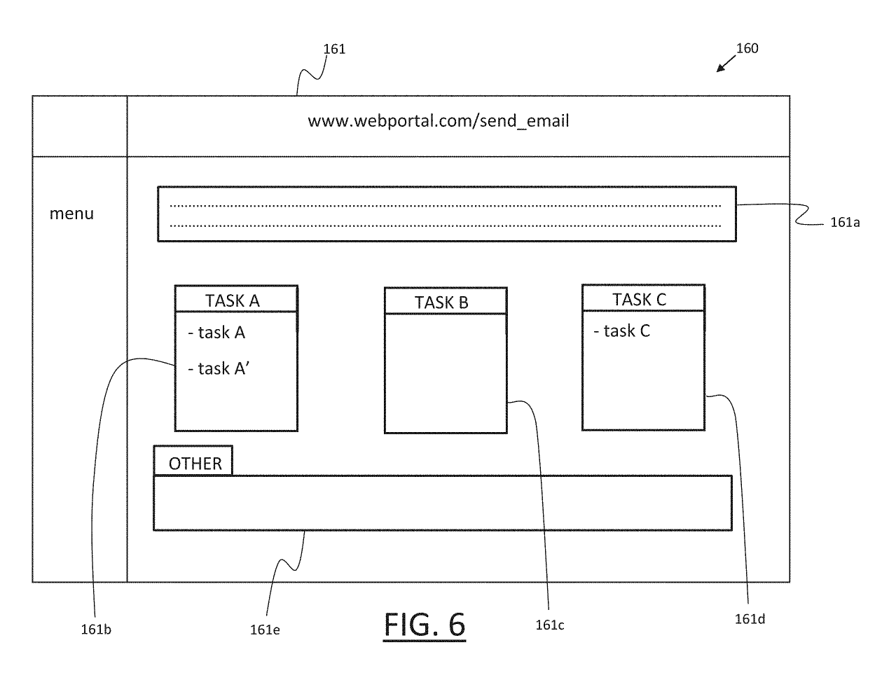

A first parameter may be the length of the email 401, typically measured as the number of words of the email 501. As an example, each word of the email 501 may increase the work value of a pre-determined amount (0.5 in the embodiment shown in FIG. 6, better discussed later). In a different embodiment, the work value related to the length of the email may be evaluated according to pre-determined ranges. As an example, the work value (or, better, the portion of the work value depending from the length of the email 401) for emails having between 1 and 100 words may be set to 5, between 101 and 200 words to 10, etc.

A further parameter may be kind and of task(s) 402 to be executed to answer the email 501. As an example, the presence of catchwords in the email 501 may suggest that the sender 201 is asking for a certain operation. Otherwise, the sender can be forced (e.g. through a web portal 160, better discussed later) to send an email compiling a pre-determined form 161. A certain work value is associated to each of the task(s) of the email 501.

A further parameter may be, further to the kind of task(s), the number of tasks 403 to be executed by the recipient 300 in order to answer to the email 501.

A further parameter may be the name (i.e. the kind) 401 of the sender 201. For example, as discussed above, a recipient may know that the operations needed to answer the emails 501 of a certain sender 201 are particularly complex and long. The work value of the emails coming from such a sender may thus be increased with respect to the others. Alternatively, e.g. when the work value 400 is used to determine a fee to be paid by the sender, it is possible that the recipient applies a discount to certain sender 201 (e.g. regular clients). The work value associated to the emails coming from such a sender may thus be lowered with respect to the emails of other senders.

As an example, in a first embodiment, the kind 401 of sender 201 may be used as a gain factor to be applied to the work value 400. This example is shown in the figures. Sender

A has a “gain factor” of 1.2 (i.e. an increased work value), sender B has a “gain factor” of 1 (i.e. no variation of the work value), while sender C has a gain factor of 0.8 (i.e. a “discounted” work value). In different embodiments, the kind 401 of sender 201 may be used as a term to be added or subtracted to calculate the work value. As an example, in an alternative embodiment, the work value of emails from sender A may be increased by 200, the work value of emails from sender B may be evaluated normally, while the work value of the emails of sender C may be lowered by 200.

A further parameter may be the number of emails sent by a sender to the recipient in a predetermined period. As an example, assuming that a sender 201 sends the same email twice in a week, the work value of the second email may be greater than the work value of the first email. This is particularly useful in case the work value is converted into a fee, to avoid spam, or unwanted and futile emails, from a certain sender.

As better discussed later, the work value 400 of the emails 501 may be used differently. In a first embodiment it may e.g. represent an estimated time needed to read the email 501. In a different embodiment, it may represent an estimated time needed to read and to answer to the email 501. In a further different embodiment, the work value 400 may be used to estimate a fee that should be paid by the sender 201 to the recipient 300. It is possible that the work value 400 may be used to carry out a plurality of the operations above disclosed, e.g. it may be used to evaluate both the time needed to read the email and the time needed to answer it. It is also possible that in such a case, the work value used to evaluate the time needed to read the email is evaluated in a different way (e.g. by means of a different combination of parameters 401-404) with respect to the work value used to evaluate the time needed to answer to an email.

According to an embodiment, the server system 100 hosts a web portal 160 (also referred as “web platform”).

The web portal 160 provides, among others, an interface for the senders 200 and the recipient 300.

The senders 200 and the recipient 300 can connect to the web portal 160 by way of a proper network, which is typically the Internet. The senders 200 and the recipient 300 may thus connect to the web portal by means of a device provided with Internet access, such as personal computer, mobile phones, tablets, etc.

Preferably, the web portal 160 allows registration of users. As known in the art, a “registered user” of a web portal, is a user that, providing identification data (e.g. a username and a password) can access particular functions of the web portal 160. Moreover, a registered user can store on the web portal 160 personal information (e.g. name, email address, payment method, etc.), that allows him to quickly operate in the web portal 160, (e.g. sending an email to a recipient 300).

With “payment method” it is meant any kind of data relating payment. As an example, a user may provide to the web portal 160 data relating its credit card, or other known digital payment services (e.g. Paypal®). Otherwise, the web platform 160 may sell “credits” that are needed to carry out certain functions.

“Credits” may thus act as a virtual coin for carrying out the operations on the web platform 160.

In a further embodiment, the web platform 160 may manage transaction with real money (e.g. by credit card) and by credits.

Preferably, the recipients 300 are all registered users of the web portal 160. In other words, if a user wants to take advantage of the present system and method for managing its incoming emails, he should register to the web portal 160.

Senders 200 may act both as registered users and as non-registered users. In an embodiment, non-registered users will be classified as non-authorized senders 202.

According to an embodiment, the system 100 provides an email address to the recipient 300. Preferably the email address shares the domain of the web portal 160, i.e. it is of the type “recipient@webportal.com”.

According to an embodiment, the recipient 300 may be allowed to use its email address freely, e.g. to send emails to both registered users of the web portal 160 and to non-registered users of the web portal 160. In particular, emails to other registered users will be normally processed by the system 100. In more detail, the recipient 300 is now actually a sender, while the registered user becomes the recipient.

If an email is sent to a non-registered user, the email may be completed automatically by the processing unit 112, in order to add an invitation to register to the web portal, to take advantage of the services provided by the system itself. Alternatively the recipient 300 may be asked if he/she wants to invite the non-registered user to register to the web portal 160.

As mentioned before, the system 110 does not divide logically the “recipients” by the “senders”. The status of “recipient” and “sender” is assigned for each email managed by the system 100.

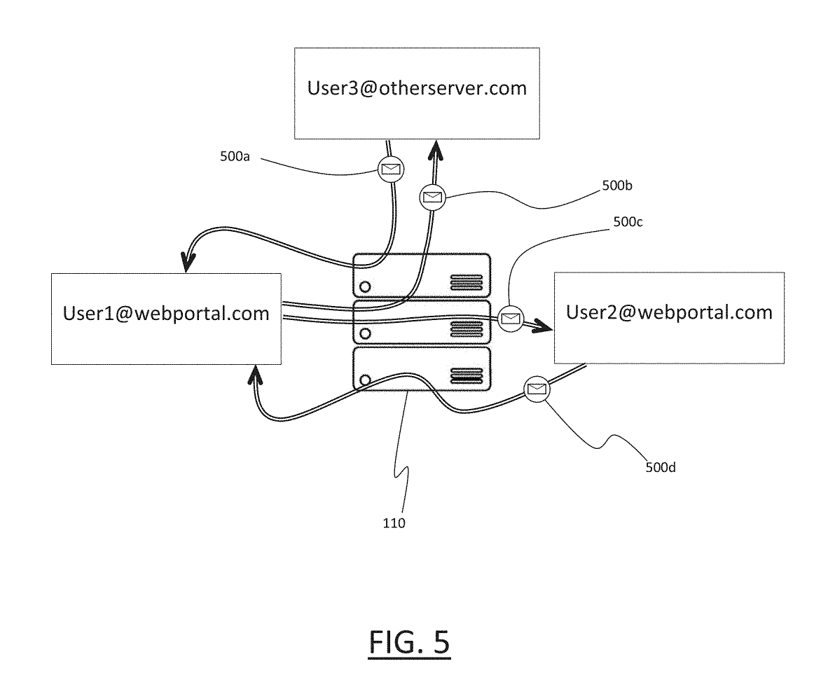

This is explained with reference to FIG. 5.

User1 and user2 are registered users of the web portal 160, and they have an email address provided by the system 100. User3 is not a registered user of the web portal 160.

Email 500a is sent by user3 to user1. In this case user3 is the sender 200 and user1 is the recipient 300. In particular, if user3 is named in the sender list 120 of user1, user3 is an authorized sender 201. If user3 is named on the block list 130 of user1, user3 is a blocked sender 203. Otherwise user1 is a non-authorized sender 202. At the reception of the email 500a, the system 100 may ask user3 to register to the web portal 160. Email 500b is sent by user1 to user3. User3 is not registered to the web platform, so the system 100 does not carry out any particular action on the email 500b. An invitation to register to the web platform 160 may be sent to user3 together with email 500b (or user1 may be asked to invite user3 to register to the web platform 160).

Email 500c is sent by user1 to user2. In this case user1 is the sender 200 and user2 is the recipient 300. In particular, if user1 is named in the sender list 120 of user2, user1 is an authorized sender 201. If user1 is named on the block list 130 of user2, user1 is a blocked sender 203. Otherwise user1 is a non-authorized sender 202.

Email 500d is sent by user2 to user1. In this case user2 is the sender 200 and user1 is the recipient 300. In particular, if user2 is named in the sender list 120 of user1, user2 is an authorized sender 201. If user2 is named on the block list 130 of user1, user2 is a blocked sender 203. Otherwise user2 is a non-authorized sender 202.

Thus, according to an embodiment, registered users of the web platform (as user1 and user2) may be either senders 200 or recipients 300 according to the case. Non-registered users may be only senders 200.

Operation of the above disclosed system 100 will be now discussed in detail.

At first, a sender 200 sends an email 500 to a recipient 300 that take advantages of the services provided by the present system 100.

As a result, the server system 100 intercepts the email 500.

The processing unit 112 then verifies the identity of the sender 200 (typically by checking the email address of the sender 200).

The sender 200 may either be an authorized sender 201 or a non-authorized sender 202.

If the sender 200 is an authorized sender 201, the processing unit determines the work value 400, according to one or more parameters 401-404.

In some embodiments, the work value 400 may be converted in a fee to be paid for allowing transmission of the email 500 to the recipient 300.

In such a case, the sender 201 is asked to pay the above mentioned fee.

This operation can be carried out in different ways.

As an example, in a first embodiment, the processing unit 112 may send an email to the sender 200, informing him/her that a fee must be paid in order to allow the email 500 to reach the recipient 300. Such an email may contain information relating the payment methods of the relevant fee, i.e. information relating how to pay the fee. In a different embodiment, wherein the server system 110 hosts a web portal 160, the sender 160 may be informed via email that he/she should connect to the web portal 160 in order to send the email. The web portal 160 may provide information relating how to pay the fee.

The fee can be paid in different ways. As an example, it may be paid in “credits” (see above). Alternatively it may be paid by credit card, digital payment means, etc.

If the fee is not paid, the processing unit 113 prevents transmission of the email 500 (now email 502). After a pre-determined time, email 502 is preferably deleted.

In an embodiment, an advice may be sent to the recipient 300 before deleting the email 502. If no action is taken by the recipient 300, email 502 is deleted.

If the work value 400 is not used to evaluate a fee for the transmission of an email 500, the email 500 (now email 501) is transmitted to the recipient 300, together with the information relating the work value 400.

If the sender 200 is not named in the sender list 120 of authorized senders 201, the sender 200 will be treated as a non-authorized sender 202.

In such a case, the email 500 of the non-authorized sender 202 is not immediately transmitted to the recipient 300. Typically, the processing unit 12 sends an (automatically generated) email to the recipient 300, asking him if he wants to add the non-authorized sender 202 to his sender list 120. Possibly, the recipient is also informed about the work value 400 of the email 500 of the non-authorized sender 202.

If the recipient 300 accepts, the non-authorized sender 201 becomes an authorized sender 202. As a result, email 500 is now sent to the recipient 300 from an authorized sender 201. Management of incoming emails 500 of authorized senders 201 has already discussed above.

If the recipient 300 refuses, the email 500 of the non-authorized sender 202 is not transmitted to the recipient 300, i.e. it becomes an email 502.

As before, After a pre-determined time, email 502 is preferably deleted. In an embodiment, an advice may be sent to the recipient 300 before deleting the email 502. If no action is taken by the recipient 300, email 502 is deleted.

The recipient 300 may be further asked if he wants to add the non-authorized sender 202 to the block list 121. As mentioned, in fact, a recipient 300 may provide a block list 121, providing identification of blocked senders 203.

If the processing unit acknowledges that an email 500 is incoming by a blocked sender 203, it will prevent the transmission of the email 500 (now email 502). Email 502 may then be deleted from the server system 110.

The sender 203 and/or the recipient 300 may be informed that the email 500 has been blocked.

In case of a web portal (or web platform) 160, the non-authorized sender 202 may be either a registered user or a non-registered user.

In case he/she is not a registered user of the web platform 160, in an embodiment, he/she may be asked to register to the web platform 160.

The system may be also provided with a spam blocker that may check the email 500 before allowing transmission of the email.

Preferably, emails 550 from authorized senders 201 bypass the spam blocker, i.e. the spam blocker can't block an email 500 from an authorized sender 201.

The spam blocker, if present, is preferably operated to check only emails 500 from non-authorized senders 202. If an email 500 is blocked by the spam blocker, preferably both the recipient 300 and the sender of the email are warned of the block.

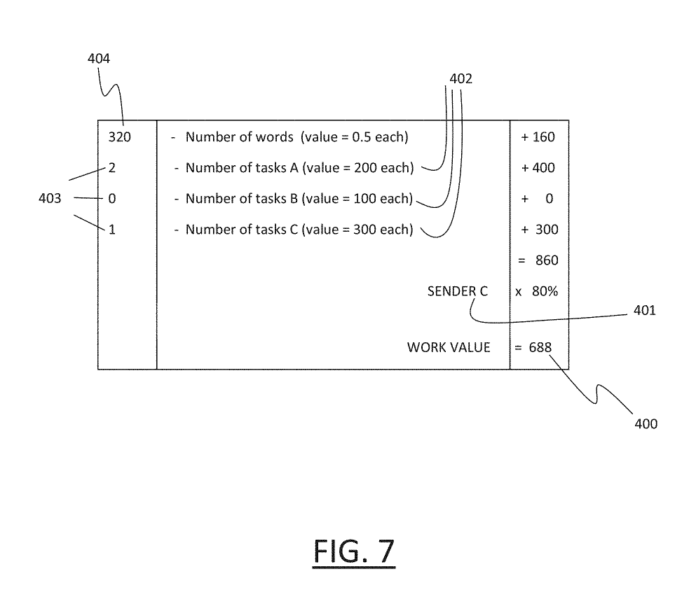

With particular reference to FIGS. 6 and 7, operation of an exemplary embodiment is discussed. Embodiment of FIG. 6 is provided with a web portal 160.

An authorized sender 201 sends an email 500 to the recipient 300.

The server system 100 intercepts the email 500, and the processing unit verifies that the sender is actually an authorized sender 201. In particular, the processing unit 112 recognizes that the sender of the email is the sender “C” named in the sender list 120 of the recipient 300. An automated email is sent back to the sender 201, inviting him to use the web portal 160 to send his email 500 to the recipient. The automated email may contain a direct link to the web portal 160, in particular to a web page of the web portal allowing the authorized sender 201 to send his email through a form 161.

The form 161 preferably contains different modules to be compiled. Forms 161a directed to the identification of the sender (e.g. it may be pre-compiled), while modules 161b-161d can be used by the sender to request certain kinds of tasks to the recipient 300. Three kinds of tasks are shown, i.e. task A, task B and task C.

A further module 161e can be used by the sender 201 to insert other requests, details, information, e.g. not relating tasks A, B and C.

Use of modules 161b-161d instead of module 161e may be promoted e.g. by applying a fee to the sender if he wants to use module 161e. As an example, such a fee may be proportional to the work value of the compiled module 161e, e.g. to the number of words used in module 161e. Furthermore, the sender may be informed that, if the recipient 300 realizes that the modules are wrongly compiled (e.g. in module 161e there is the request of a task A), he may be asked to resend his email properly compiling the modules 161b-161e. A fee may be applied to the subsequent email, in order to pay back the recipient of the time spent reading the previously wrongly compiled email. Once the authorized sender 201 finished compiling the modules 161b-161d, the email 501 is transmitted to the recipient 300, together with the evaluation of the work value 400 of the email.

In FIG. 7, such an evaluation is shown in detail. The authorized sender 201 used 320 words. The recipient 300 set a work value of 0.5 for each word. As a result, the contribution to the total work value 400 of the number of fords is 160.

The authorized senders asked for two tasks A and for a task C. No tasks B were asked. Work value for each task A was set by the recipient 300 to 200, for each task B was set to 100, while for each task C was set to 300. As a result, the contribution of contribution of tasks A to the work value is equal to 400 (i.e. 2×200), the contribution of contribution of tasks B to the work value is equal to 0 (i.e. 0×100), while the contribution of contribution of tasks C to the work value is equal to 300 (i.e. 1×300).

The sum of the work value should thus be 860. However, the recipient 300 had set that the work value of the emails coming from sender “C” should be lowered to the 80%. As a result, the total work value 400 of the email 500 is 688.

Furthermore, the processing unit 112 may recognize that 200 words were used in module 161e. The work value of module 161e is thus 200×0.5×0.8=80 (i.e. the number of words x the work value of each word x the “gain factor” of sender C). As mentioned, the processing unit 112 may thus convert the work value of module 161e into a fee to be paid by the sender to the recipient for the transmission of the email 500.

Such a fee may be paid in “credits”, which may be used subsequently by the recipient to carry out other operations on the web portal 160. In an embodiment, the recipient 300 may convert the credits obtained by the incoming emails in real money (e.g. by a credit entry in his/her bank account) after reaching a pre-determined number of credits. Part of the transactions on the web portal may be withheld by the web portal itself as a commission.

While exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents.

1) A method for managing a transmission of emails from a sender to a recipient, comprising the steps of:
(a) providing a server system comprising one or more servers, the server system comprising a processing unit;
(b) providing a recipient list to the server system, comprising identification of one or more recipients;
(c) providing a sender list for each recipient of said recipient list to the server system, said sender list comprising identification of one or more authorized senders;
wherein the processing unit
(s1) receives an email sent by a sender towards a recipient of said recipient list;
(s2) prevents transmission of the email from the server system to the recipient until the sender is an authorized sender;
(s3) assigns a work value to the emails transmitted to the recipient;
(s4) counts the total work value of the emails transmitted to the recipient.

2) The method of claim 1, wherein said work value is assigned as a function of at least one parameter selected from: name of sender, number of words of the email, kind of task(s) to be executed by the recipient, number of tasks to be executed by the recipient, number of emails sent by the sender towards the recipient in a predetermined period.

3) The method of claim 1, wherein said work value is converted into a fee to be paid by the sender to the recipient.

4) The method of claim 3, wherein the processing unit prevents transmission of emails from a sender to a recipient until the fee is paid.

5) The method of claim 1, wherein the processing unit, between said steps (s1) and (s2):
(s1.1) determines that the sender is not an authorized sender;
(s1.2) asks the recipient to add the sender to the sender list.

6) The method according to claim 1, wherein the server system comprises a memory, said recipient list and/or said sender list being stored on said memory.

7) The method according to claim 1, wherein the server system hosts a web platform, configured to accept a number of registered users.

8) The method according to claim 7, wherein the recipients of the recipient list are registered users of said web platform.

9) The method according to claim 8, wherein the processing unit, after said step (s1) of receiving an email from a sender
(s1.3) determines that the sender is not registered to the web platform;
(s1.4) invites the sender to register to the web platform;

10) The method according to claim 1, wherein the recipients have an email account on a server of said server system.

11) A system for managing transmission of emails from a sender to a recipient, the system comprising a server system comprising one or more servers, and a processing unit, the server system being configured to obtain:
a recipient list comprising identification of one or more recipients;
a sender list for each recipient of said recipient list, said sender list comprising identification of one or more senders wherein the server system is configured to run computer executable instructions to receive an email sent by a sender towards a recipient of said recipient list;
prevent transmission of the email from the server system to the recipient until the sender is an authorized sender;
assign a work value to the emails transmitted to the recipient;
count the total work value of the emails transmitted to a recipient.

12) The system according to claim 11, comprising a memory, said recipient list and/or said sender list being stored on said memory.

13) The method according to claim 10, wherein the server system hosts a web platform configured to accept a number of registered users.
